(19) United States
(12) Patent Application Publication
(10) Pub. No.: US 2004/0001692 A1
(43) Pub. Date: Jan. 1, 2004

(54) Image recording method, image recording apparatus, and image recording medium

(75) Inventors: Koichi Okada, Odawara-shi (JP); Yasunori Ohta, Hadano-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/603,933

(22) Filed: Jun. 26, 2003

(30) Foreign Application Priority Data
Jun. 28, 2002 (JP) 2002-188894

(51) Int. Cl. H04N 5/76

(52) U.S. Cl. 386/46; 386/95; 386/127

(57) ABSTRACT

Attribute information of a film and apparatus information of an image recording apparatus are converted into visible information, which is recorded on the film in a predetermined location thereon. If the film has a central area serving as an image recording area where a visible image is recorded, then the visible information is recorded in an upper area, for example, in a region around the image recording area. The visible information is recorded in a display pattern that can easily be recognized by the user.

### BACKGROUND OF THE INVENTION

1. Field of the Invention

The present invention relates to a method of and an apparatus for recording image data as a visible image on an image recording medium, and an image recording medium for recording image data as a visible image thereon.

2. Description of the Related Art

In recent years, computer-assisted diagnosis apparatus such as CT (Computed Tomography) apparatus, CR (Computed Radiography) apparatus, MRI (Magnetic Resonance Imaging) apparatus, etc. have widely been used in the medical field. Radiation image information represented by an electric signal generated by such computer-assisted diagnosis apparatus is transmitted to an image processing apparatus, processed as desired thereby, and then outputted to an image recording medium such as a photographic film or the like.

An image recording apparatus for recording radiation image information on an image recording medium operates by removing a sheet-like image recording medium from a stack of sheet-like image recording mediums and delivering the removed sheet-like image recording medium to an image recording unit. In the image recording unit, a laser beam that has been modulated depending on radiation image information to be recorded is applied to the sheet-like image recording medium, thereby producing a radiation image that has been processed as desired on the sheet-like image recording medium.

It has been proposed for such an image recording apparatus to store image processing information input from a terminal device or a console, together with identification information of an image recording medium, as a file into a memory, read the image processing information of an image to be recorded on the image recording medium from the memory based on the identification information of the image recording medium when the image is to be recorded on the image recording medium, and record the image on the image recording medium based on the read image processing information (see Japanese Laid-Open Patent Publication No. 59-28146, for example).

In conventional image recording apparatus, it has been customary to record, on image recording mediums, information inherent in examinees (patients) to be imaged, e.g., the genders, names, etc., input information such as exposure conditions, and input information such as image processing conditions including gradation processing details, frequency processing details, etc. However, it has not been practiced to record attributes of image recording mediums themselves, e.g., the terms of validity of image recording mediums, the types thereof, etc., and information of the image recording apparatus (apparatus information) at the time images were recorded on image recording mediums, e.g., the dates and times when packages of image recording mediums were opened, the temperatures at which images recorded on image recording mediums were developed, etc.

Therefore, when an image recording medium used by a user has a problem and returned from the user to the manufacturer for inspection, no sufficient information is available about the situation in which an image has been recorded on the image recording medium. The manufacturer is thus unable to make a sufficient analysis of possible causes of the problem which the image recording medium is having.

### SUMMARY OF THE INVENTION

It is therefore an object of the present invention to provide an image recording method, an image recording apparatus, and an image recording medium which make it possible for the operator to clearly recognize the situation in which an image has been recorded on an image recording medium when the image recording medium is returned from the user, for example.

According the present invention, there is provided a method of recording image data as a visible image on an image recording medium, comprising the step of recording information including at least attributes of the image recording medium on the image recording medium in addition to an image recorded on the image recording medium.

According the present invention, there is also provided an apparatus for recording image data as a visible image on an image recording medium, comprising first means for recording an image on the image recording medium, and second means for recording information including at least attributes of the image recording medium on the image recording medium.

According the present invention, there is also provided an image recording medium for recording image data as a visible image thereon, wherein information including at least attributes of the image recording medium is recorded in an area of the image recording medium other than an area thereof in which the visible image is recorded.

With the above arrangement, even if the image recording medium is returned from the user, since the information including at least attributes of the image recording medium is recorded on the image recording medium, the situation in which the image has been recorded on the image recording medium can clearly be recognized.

The image recording medium may be removed from a package of a plurality of image recording mediums, and the image data may be recorded as the visible image on the removed image recording medium, and the information including the attributes of the image recording medium may comprise information indicated on at least the package.

It is preferable that the information is recorded in an area of the image recording medium other than an area thereof in which the image is recorded. The information may also include apparatus information of an apparatus which records the image on the image recording medium.

The information may be recorded as visible information, or may be recorded as magnetic information on a magnetic recording medium provided on the image recording medium. If the information is recorded as visible information, then the information should preferably be converted into a predetermined display pattern and then recorded on the image recording medium. The predetermined display pattern may be in the form of a pattern that the human being can easily recognize visually, or may be in the form of a bar code that can be read by a computer.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of an image recording apparatus according to the present invention;

FIG. 2 is a perspective view, partly in phantom, of a package to be loaded into the image recording apparatus according to the present invention;

FIG. 3 is a perspective view, partly in phantom, of the package, showing a reverse side of the package;

FIG. 4 is a vertical cross-sectional view showing an internal structure of the image recording apparatus according to the present invention;

FIG. 5 is a block diagram of a control system of the image recording apparatus according to the present invention;

FIG. 6 is a plan view showing a location where visible information is recorded on a film;

FIG. 7A is a plan view showing a film on which a bar code is recorded instead of visible information;

FIG. 7B is a plan view showing a film on which visible information and a bar code are recorded;

FIG. 8A is a plan view showing a film on which magnetic information is recorded instead of visible information on a magnetic recording medium;

FIG. 8B is a plan view showing a film on which visible information is recorded and magnetic information is recorded on a magnetic recording medium; and

FIG. 9 is a flowchart of a processing sequence of the image recording apparatus according to the present invention.

### DESCRIPTION OF THE PREFERRED EMBODIMENT

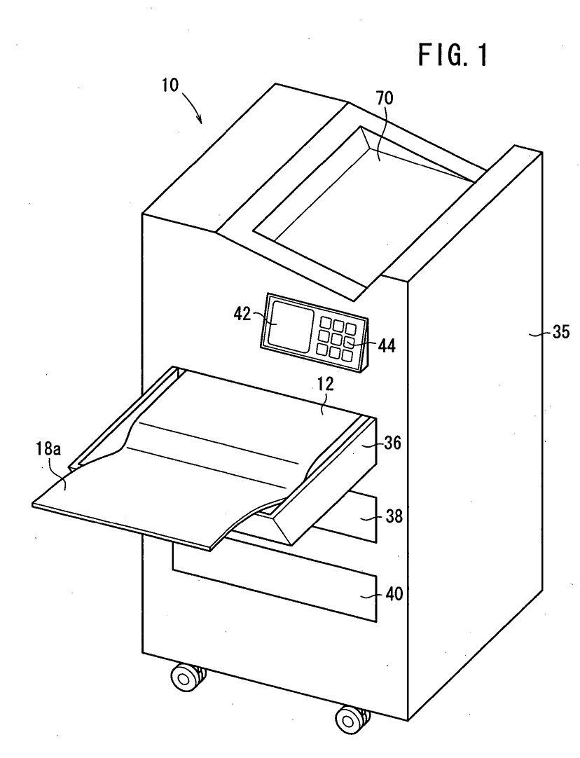

An image recording method, an image recording apparatus, and an image recording medium according to an embodiment of the present invention will be described below with reference to FIGS. 1 through 9.

An image recording medium 10 shown in FIG. 1 records radiation image information supplied from a CT apparatus, a CR apparatus, an MRI apparatus, or the like on an image recording medium, and outputs the image recording medium with the recorded radiation image information.

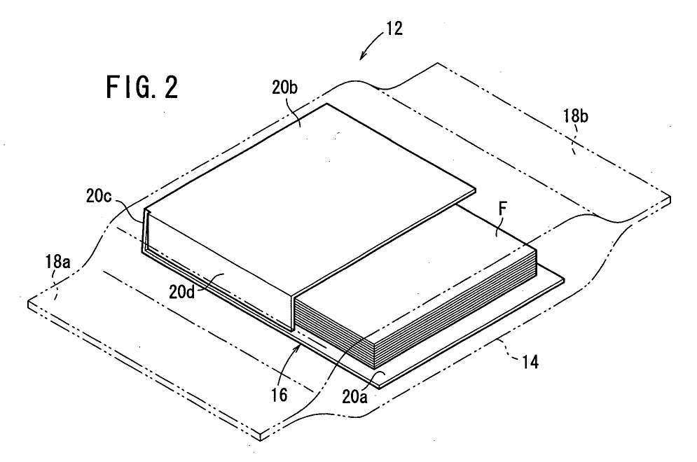

As shown in FIG. 2, a package 12 to be loaded into the image recording medium 10 includes a light-shielding bag 14, a stack of sheet-like films F as image recording mediums stored in a light-shielded fashion in the light-shielding bag 14, and a protective sheet 16 of paper placed in the light-shielding bag 14 for protecting the films F.

The light-shielding bag 14 has a pair of fins 18a, 18b on its front and rear ends, respectively, each having a predetermined width. The protective sheet 16 comprises a folded sheet of corrugated cardboard, for example. The protective sheet 16 has a lower panel 20a placed beneath the lowermost one of the films F, an upper panel 20b placed over the uppermost one of the films F, a side panel 20c interconnecting the upper and lower panels 20a, 20b, and a side panel 20d joined to the upper panel 20b and positioned along side edges of the films F near the fin 18a.

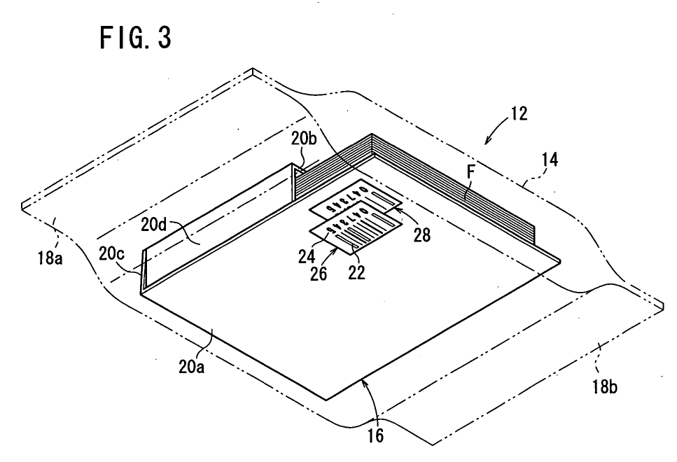

As shown in FIG. 3, the light-shielding bag 14 carries a bar-code label 26 applied to a lower outer surface thereof beneath the lower panel 20a of the protective sheet 16 near the fin 18a. The bar-code label 26 has a printed bar code 22 recording identification information for use as an index of attribute information including the size, sensitivity, production time, production place, production lot number, production company, etc., and printed numerical data 24 corresponding to the identification information represented by the bar code 22. Similarly, the lower panel 20a of the protective sheet 16 carries a bar-code label 28 applied to a lower surface thereof. The bar-code label 28 is identical to the bar-code label 26 and has the same bar code and numerical data as the bar code 22 and the numerical data 24.

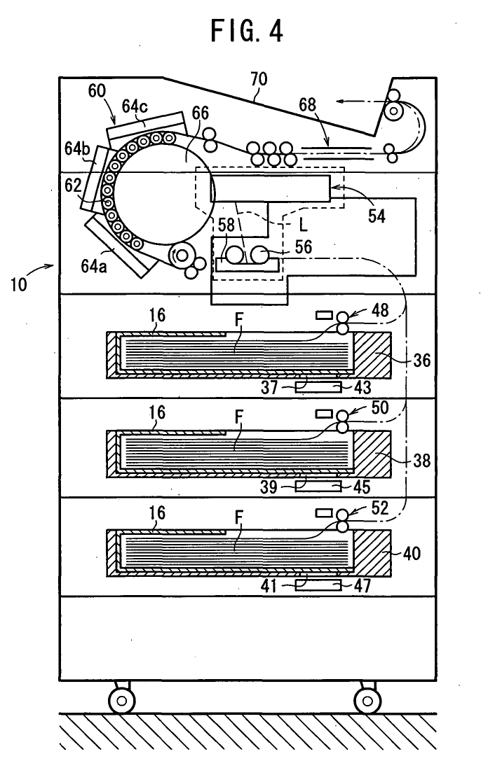

Structural details of the image recording apparatus 10 will be described below with reference to FIGS. 1 and 4. The image recording apparatus 10 has a plurality of support bases 36, 38, 40 for receiving corresponding packages 12 loaded thereinto from one side of a housing 35 of the image recording apparatus 10. The housing 35 has a side panel supporting thereon a display unit 42 for displaying operation statuses of the image recording apparatus 10 and desired operation commands, and a data input unit 44 for entering data into the image recording apparatus 10. The display unit 42 and the data input unit 44 are positioned above the uppermost support base 36.

The housing 35 accommodates therein sheet feed mechanisms 48, 50, 52 disposed closely to the support bases 36, 38, 40, respectively, for removing the films F, one by one, from the loaded packages 12, which are open, in the image recording apparatus 10. The support bases 36, 38, 40 have respective openings 37, 39, 41 defined respectively in lower panels thereof in alignment with the bar-code labels 26, 28 applied to the bags 14 and the protective sheets 16 of the loaded packages 12. Bar-code readers 43, 45, 47 are disposed respectively below the openings 37, 39, 41 for reading the bar-code labels 26, 28.

The housing 35 also accommodates therein a recording unit 54 disposed above the uppermost support base 36. The recording unit 54 has an image recorder 55, a display pattern converter 90, and an information recorder 96.

The image recorder 55 applies a laser beam L that has been modulated by radiation image information to be recorded, to a film F fed thereto to record a latent radiation image on the film F.

The display pattern converter 90 converts attribute information of the film F, etc. into a display pattern of data that can easily be recognized by the user, and outputs the converted data to the information recorder 96. For example, the display pattern converter 90 converts year/month/date data “020325” included in the attribute data into a display pattern of data “2002/3/25”.

The information recorder 96 records data supplied from the display pattern converter 90 on the film F in a predetermined location thereon.

In the recording unit 54, the film F is fed while it is being pressed against a plate 58 by rollers 56.

A thermal development unit 60 is disposed in an upper portion of the housing 35 on one side of the recording unit 54. The thermal development unit 60 heats a film F with a latent image of radiation image information recorded thereon to develop the latent image into a visible image. The thermal development unit 60 comprises a plurality of rollers 62 for feeding a film F along a curved path, a plurality of plate heaters 64a-64c disposed successively along the curved path for heating the film F being fed by the rollers 62, and a drum 66 held against the rollers 62 for rotating the rollers 62.

A cooling unit 68 is disposed in an uppermost portion of the housing 35 contiguously to the thermal development unit 60. The cooling unit 68 cools the film F carrying the visible image developed by the thermal development unit 60. The film F cooled by the cooling unit 68 is discharged onto a discharge tray 70 on an upper surface of the housing 35.

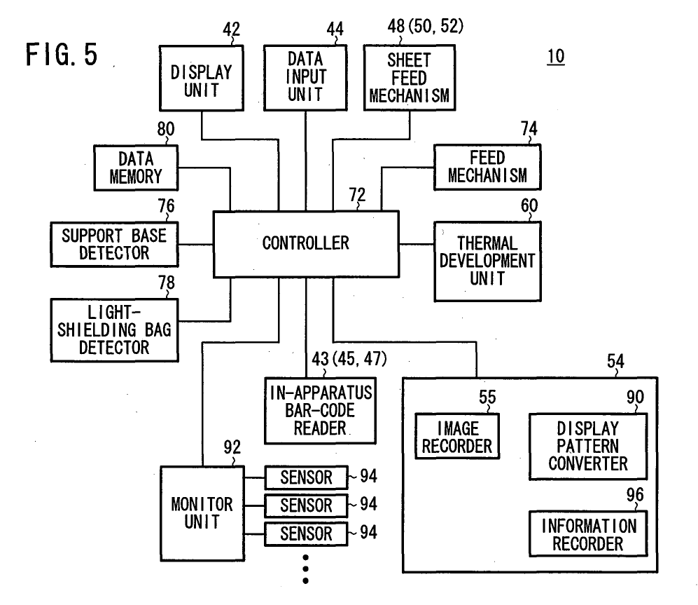

As shown in FIG. 5, the image recording apparatus 10 is controlled in its overall operation by a controller 72. The recording unit 54, the thermal development unit 60, the bar-code readers 43, 45, 47, the display unit 42, and the data input unit 44 are connected to the controller 72. The controller 72 controls the sheet feed mechanisms 48, 50, 52 and also a feed mechanism 74 for feeding films F in the image recording apparatus 10.

To the controller 72, there are also connected a support base detector 76 for detecting when the support bases 36, 38, 40 are placed in the image recording apparatus 10, and a light-shielding bag detector 78 for detecting whether there is a light-shielding bag 14 in the image recording apparatus 10 or not. A data memory 80 for storing identification information read by the bar-code readers 43, 45, 47 is also connected to the controller 72.

To the controller 72, there is further connected a monitor unit 92 for monitoring a system status in the image recording apparatus 10. The monitor unit 92 converts detected values from various sensors 94 connected thereto into a string of data, and sends the string of data to the controller 72.

The controller 72 reads attribute information of films F which corresponds the identification information stored in the data memory 80, from the data memory 80, and sends the attribute information to the display pattern converter 90.

As described above, the display pattern converter 90 converts attribute information of films F, etc. into a display pattern of data that can easily be recognized by the user, and outputs the converted data to the information recorder 96.

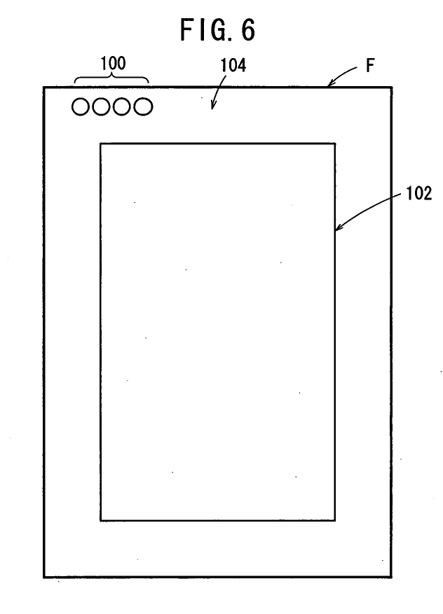

The information recorder 96 records data sent from the display pattern converter 90 as visible information 100 on a film F in a predetermined location thereon. As shown in FIG. 6, if the film F has a central area serving as an image recording area 102 where a visible image is recorded, then the information recorder 96 records the visible information 100 in an upper area 104, for example, in a region around the image recording area 102.

If the film F has a black background, then the information recorder 96 records the visible information 100 as white characters and marks. If the film F is transparent, then the information recorder 96 records the visible information 100 as black characters and marks.

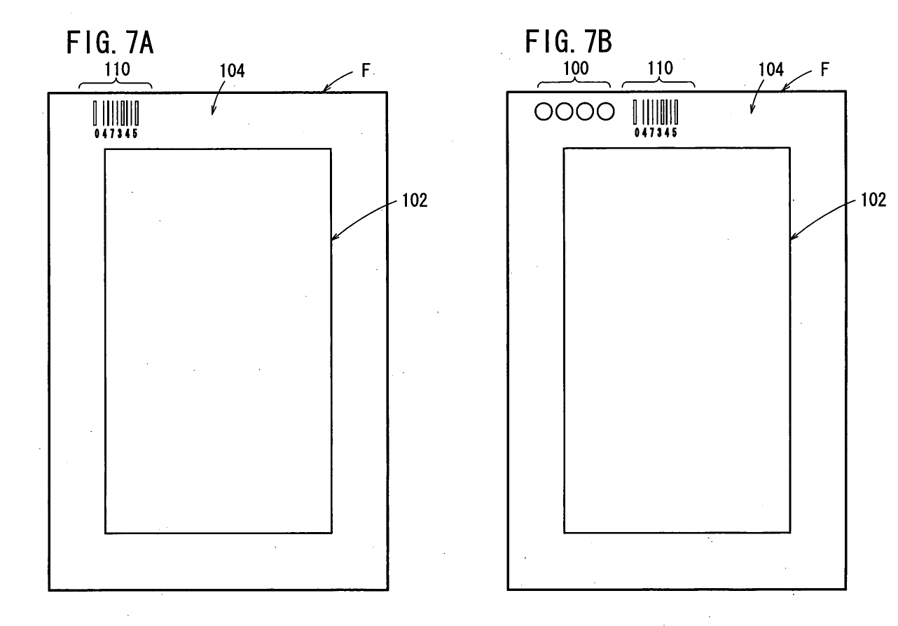

Alternatively, as shown in FIG. 7A, the information recorder 96 may record a bar code 110 (a one-dimensional bar code or a two-dimensional bar code) instead of the visible information 100, or as shown in FIG. 7B, the information recorder 96 may record a bar code 110 as well as the visible information 100.

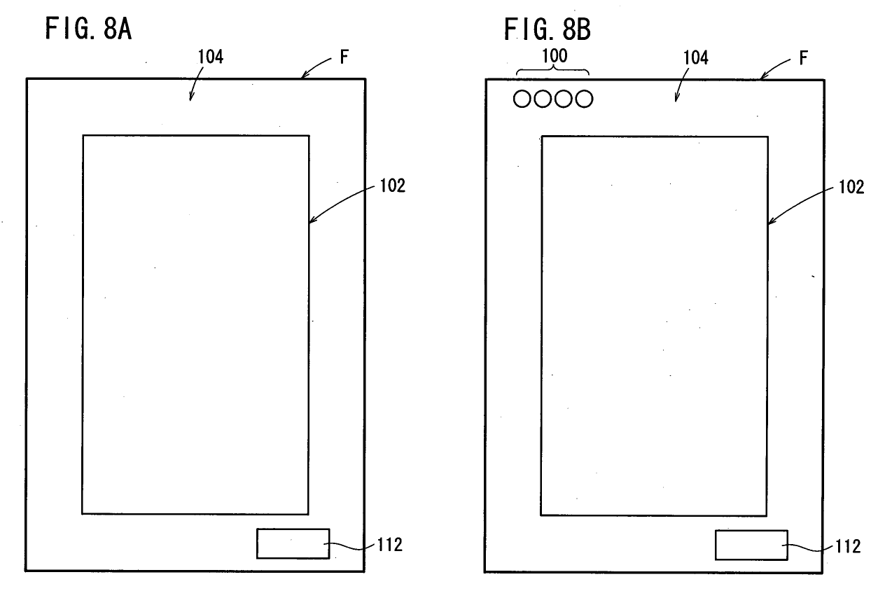

Further alternatively, as shown in FIG. 8A, a magnetic recording medium 112 may be provided in the region around the image recording area 102, and magnetic information representing the attribute information may be recorded on the magnetic recording medium 112, or as shown in FIG. 8B, the visible information 100 may be recorded in an upper area, for example, in the region around the image recording area 102, and magnetic information representing the attribute information may be recorded on the magnetic recording medium 112.

In addition to the attribute information of the film F, apparatus information of the image recording apparatus 10 may be recorded on the film F. For example, such apparatus information represents the dates and times when packages 12 of films F were opened, the total number of films F which have been output so far from the image recording apparatus 10, information as to devices connected to the image recording apparatus 10, information within the image recording apparatus 10 (development temperature, settings of internal devices thereof, etc.), the serial number of the image recording apparatus 10, the ordinal number of the film F that is presently output, and version information of basic software and application software that the image recording apparatus 10 is using.

The apparatus information may comprise a string of data supplied from the monitor unit 92 (see FIG. 5) to the controller 72, i.e., information representing detected values from the sensors 94 as a string of data. When such a string of data is supplied through the display pattern converter 90 to the information recorder 96, the apparatus information as well as the attribute information of the film F can be recorded as the visible information 100. The apparatus information may alternatively be recorded as magnetic information.

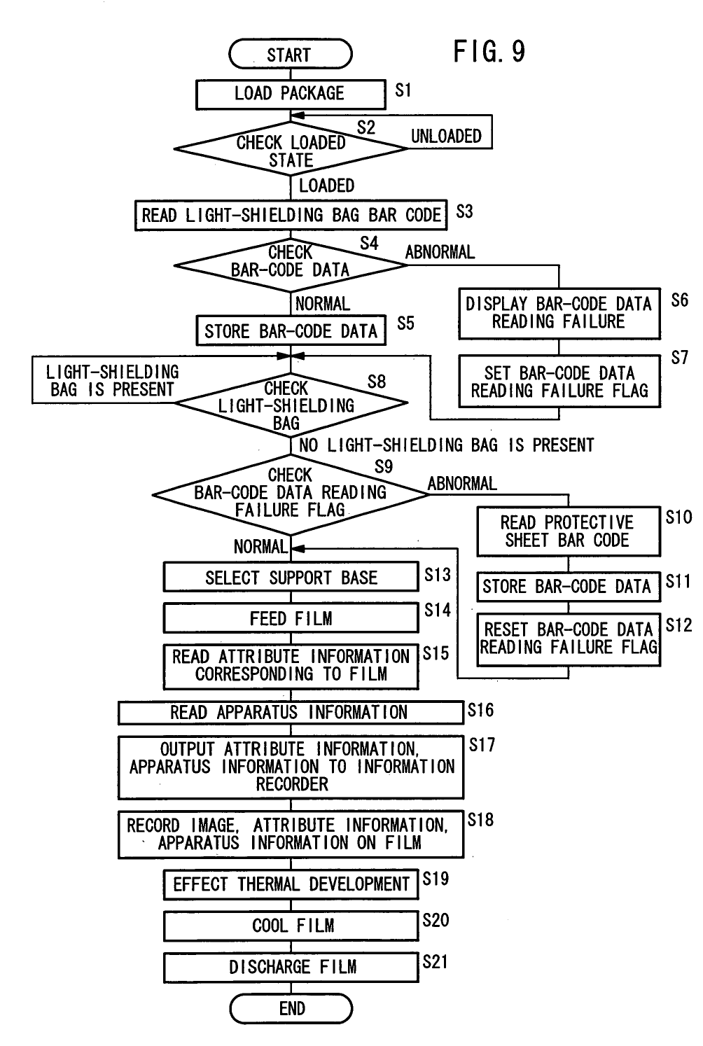

The image recording apparatus 10 and the packages 12 loaded thereinto are basically constructed as described above. A processing sequence of the image recording apparatus 10 will be described below with reference to FIG. 9.

In a preparatory stage, as shown in FIG. 1, one of the support bases 36, 38, 40 (the support base 36 in the illustrated embodiment) is pulled out, and a package 12 with the bar-code label 26 (see FIG. 3) applied to the light-shielding bag 14 is placed on the support base 36. At this time, the bar-code label 26 can be detected through the opening 41 defined in the support base 36. After the package 12 has been placed on the support base 36, an end of the fin 18b is cut off. Nevertheless, the films F stored in the light-shielding bag 14 are kept in a light-shielded manner because the light-shielding bag 14 is pressed against an inner peripheral wall of the support base 36. The other fin 18a extends forwardly from the support base 36 out of the image recording apparatus 10.

After the package 12 has thus been placed on the support base 36, the support base 36 is loaded into the housing 35 by the operator in step S1 in FIG. 9. If the controller 72 confirms that the support base 36 is loaded into the housing 35 based on a detected signal from the support base detector 76 in step S2, then the bar-code reader 43 reads the bar code 22 recorded on the bar-code label 26 applied to the light-shielding bag 14 of the package 12 placed on the support base 36 in step S3.

Having loaded the support base 36 into the housing 35, the operator pulls the exposed fin 18a of the light-shielding bag 14. At this time, the films F are left in the housing 35 while being held by the protective sheet 16 and on the support base 36.

The controller 72 checks bar-code data read from the bar code 22 by the bar-code reader 43 in step S4. The controller 72 may check bar-code data according to a known process such as a check digit process, for example.

If the controller 72 judges that the bar-code data has properly been read as a result of the check, then the controller 72 stores identification information represented by the bar-code data as well as information representing the support base 36 in the data memory 80 in step S5.

If the controller 72 judges that the bar-code data has not properly been read as a result of the check, then the controller 72 displays a reading failure on the display unit 42 in step S6, and sets a bar-code data reading failure flag in step S7. Such a reading failure may occur when the operator pulls the light-shielding bag 14 out of the housing 35 before the bar-code reader 43 completes the reading of the bar code 22, or when the bar-code reader 43 suffers an error in reading the bar code 22.

After having stored identification information represented by the bar-code data in the data memory 80 or set a bar-code data reading failure flag, the controller 72 checks if the light-shielding bag 14 has been removed or not based on a detected signal from the light-shielding bag detector 78 in step S8. Thereafter, the controller 72 checks a bar-code data reading failure flag in step S9.

If the controller 72 confirms that a bar-code data reading failure flag has been set in step S9, then the bar-code reader 43 reads the bar code 22 recorded on the bar-code label 28 applied to the protective sheet 16 on the support base 36 in step S10.

The controller 72 then stores identification information represented by the bar-code data as well as information representing the support base 36 in the data memory 80 in step S11. Then, in step S12, the controller 72 resets the bar-code data reading failure flag which has been set in step S7.

If the bar-code data have been input or no bar-code data reading failure flag has been set, or a bar-code data reading failure flag has been reset, as described above, then the controller 72 starts a process of recording radiation image information on a desired film F.

The controller 72 selects one of the support bases 36, 38, 40 which stores the desired film F, using the identification information of films F and information as to the support bases 36, 38, 40 which stores those films F in step S13.

After having selected one of the support bases 36, 38, 40, the controller 72 activates the sheet feed mechanisms 48, 50, 52 and the feed mechanism 74, feeding the desired film F to the recording unit 54 in step S14.

The controller 72-reads attribute information corresponding to the identification information of the selected film F from the data memory 80 in step S15, and also reads apparatus information of the image recording apparatus 10 through the monitor unit 92 in step S16. Thereafter, the controller 72 outputs the attribute information and the apparatus information thus read via the display pattern converter 90 to the information recorder 96 in step S17.

The film F that has been fed to the recording unit 54 is sandwiched and fed by the rollers 56 and the plate 58 in an auxiliary scanning direction, and the recording unit 54 records a radiation image, the attribute information of the film F, and the apparatus information of the image recording apparatus 10 on the film F in step S18. Specifically, a laser beam L modulated by radiation image information is applied by the image recorder 55 to the film F in a main scanning direction, thus recording a two-dimensional latent image represented by the radiation image information on the film F. The attribute information and the apparatus information from the controller 72 are converted into a display pattern easily recognizable by the user by the display pattern converter 90, and then recorded on the film F in a predetermined area thereon by the information recorder 96.

The film F with the radiation image, the attribute information, and the apparatus information recorded thereon is then fed to the thermal development unit 60. In the thermal development unit 60, the radiation image, the attribute information, and the apparatus information are developed into a visible image by the heat applied by the plate heaters 64a-64c while the film F is being fed by the rollers 62 and the drum 66 in step S19. The film F with the visible image is then cooled by the cooling unit 68 in step S20, and thereafter discharged onto discharge tray 70 in step S21.

In the present embodiment, at least attribute information of a film F (and apparatus information of the image recording apparatus 10) is recorded on the periphery of the film in addition to an image recorded thereon. Therefore, even when the film is returned from the user to the manufacturer, the manufacturer can clearly recognize the situation in which the image has been recorded. As a result, even if the film F returned from the user suffers a failure, the film F can quickly and optimally be processed based on the attribute information (and apparatus information of the image recording apparatus 10) recorded on the film F.

In the illustrated embodiment, attribute information of a film F, etc. is recorded on the film F by the information recorder 96 at the same time that an image is recorded on the film F by the image recorder 55. However, attribute information of a film F, etc. and an image may be recorded on the film F by the laser beam L by the image recorder 55. According to this modification, if the information from the display pattern converter 90 is input to the image recorder 55, then the information recorder 96 may be dispensed with, so that the circuit arrangement of the control system shown in FIG. 5 may be simplified.

Alternatively, attribute information of a film F, etc. may be recorded on the film F after an image is recorded on the film F.

As described above, with the image recording method, the image recording apparatus, and the image recording medium according to the present invention, even when an image recording medium is returned from the user to the manufacturer, the manufacturer can clearly recognize the situation in which an image has been recorded on the image recording medium.

Although a certain preferred embodiment of the present invention has been shown and described in detail, it should be understood that various changes and modifications may be made therein without departing from the scope of the appended claims.

What is claimed is:

1. A method of recording image data as a visible image on an image recording medium, comprising the step of:
recording information including at least attributes of the image recording medium on said image recording medium in addition to an image recorded on the image recording medium.

2. A method according to claim 1, wherein said image recording medium is removed from a package of a plurality of image recording mediums, and the image data is recorded as the visible image on the removed image recording medium, and wherein said information including the attributes of the image recording medium comprises information indicated on at least said package.

3. A method according to claim 1, wherein said information is recorded in an area of said image recording medium other than an area thereof in which said image is recorded.

4. A method according to claim 1, wherein said information also includes apparatus information of an apparatus for recording the image on said image recording medium.

5. A method according to claim 1, wherein said information is recorded as visible information on said image recording medium.

6. A method according to claim 5, further comprising the steps of:
converting said information into a predetermined display pattern; and
recording said predetermined display pattern on said image recording medium.

7. An apparatus for recording image data as a visible image on an image recording medium, comprising:
first means for recording an image on the image recording medium; and
second means for recording information including at least attributes of the image recording medium on said image recording medium.

8. An apparatus according to claim 7, wherein said second means comprises means for recording said information in an area of said image recording medium other than an area thereof in which said image is recorded by said first means.

9. An apparatus according to claim 7, wherein said second means comprises means for recording said information as visible information.

10. An apparatus according to claim 7, further comprising:
third means for converting said information including the attributes of the image recording medium into a predetermined display pattern, and outputting said predetermined display pattern to said second means.

11. An apparatus according to claim 7, further comprising:
fourth means for removing said image recording medium from a package of a plurality of image recording mediums;
said first means comprising means for recording the image data as the visible image on the removed image recording medium; and
said second means comprising means for recording information indicated on at least said package as said information including the attributes of the image recording medium.

12. An image recording medium for recording image data as a visible image thereon, wherein information including at least attributes of the image recording medium is recorded in an area of said image recording medium other than an area thereof in which said visible image is recorded.
